(19) United States
(12) Patent Application Publication
(10) Pub. No.: US 2026/0081682 A1
(43) Pub. Date: Mar. 19, 2026

(54) MINIMIZING PHASE-DELAY-INDUCED SIGNAL LOSS IN OPTICAL FIBERS

(71) Applicant: AT&T Communications Services India Private Limited, Bangalore (IN)

(72) Inventor: Mritunjay Pandey, Bangalore (IN)

(21) Appl. No.: 18/890,737

(22) Filed: Sep. 19, 2024

(51) Int. Cl. H04B 10/079; H04B 10/255; H04B 10/2557; H04B 10/2563; H04J 14/02

(52) U.S. Cl. CPC H04B 10/0793; H04B 10/255; H04B 10/2557; H04B 10/2563; H04J 14/0221

(57) ABSTRACT

A method includes calculating a phase of a light pulse that is propagating along an optical fiber of a fiber broadband communications network, calculating a change in the phase of the light pulse due to a nonlinearity, determining a cause of a portion of the change in the phase, wherein the cause is at least one of: a self-phase modulation, a cross-phase modulation, or a four-wave mixing, and initiating at least one action to mitigate the nonlinearity, wherein the at least one action is selected based on the cause that is determined.

The present disclosure relates generally to fiber broadband network infrastructure, and relates more particularly to devices, non-transitory computer-readable media, and methods for minimizing phase-delay-induced signal loss in optical fibers of a dense wavelength division multiplexing network.

### BACKGROUND

Fiber broadband networks are networks that transmit broadband signals in the form of pulses of light that are carried through optical fibers. The light is a form of carrier wave that is modulated to carry the broadband signals, which may contain voice, video, telemetry, and other data.

### SUMMARY

In one example, the present disclosure describes a device, computer-readable medium, and method for minimizing phase-delay-induced signal loss in optical fibers of a dense wavelength division multiplexing network. For instance, in one example, a method for minimizing phase-delay-induced signal loss in optical fibers of a dense wavelength division multiplexing network includes calculating a phase of a light pulse that is propagating along an optical fiber of a fiber broadband communications network, calculating a change in the phase of the light pulse due to a nonlinearity, determining a cause of a portion of the change in the phase, wherein the cause is at least one of: a self-phase modulation, a cross-phase modulation, or a four-wave mixing, and initiating at least one action to mitigate the nonlinearity, wherein the at least one action is selected based on the cause that is determined.

In another example, a non-transitory computer-readable medium stores instructions which, when executed by a processing system including at least one processor, cause the processing system to perform operations. The operations include calculating a phase of a light pulse that is propagating along an optical fiber of a fiber broadband communications network, calculating a change in the phase of the light pulse due to a nonlinearity, determining a cause of a portion of the change in the phase, wherein the cause is at least one of: a self-phase modulation, a cross-phase modulation, or a four-wave mixing, and initiating at least one action to mitigate the nonlinearity, wherein the at least one action is selected based on the cause that is determined.

In another example, a system includes a processing system including at least one processor and a non-transitory computer-readable medium storing instructions which, when executed by the processing system, cause the processing system to perform operations. The operations include calculating a phase of a light pulse that is propagating along an optical fiber of a fiber broadband communications network, calculating a change in the phase of the light pulse due to a nonlinearity, determining a cause of a portion of the change in the phase, wherein the cause is at least one of: a self-phase modulation, a cross-phase modulation, or a four-wave mixing, and initiating at least one action to mitigate the nonlinearity, wherein the at least one action is selected based on the cause that is determined.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for minimizing phase-delay-induced signal loss in an optical fiber of a fiber broadband communications network may operate;

FIG. 2 illustrates a flowchart of an example method for minimizing phase-delay-induced signal loss in an optical fiber of a fiber broadband communications network, according to the present disclosure; and

FIG. 3 illustrates a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium minimizing phase-delay-induced signal loss in optical fibers of a dense wavelength division multiplexing (DWDM) network. As discussed above, fiber broadband networks are networks that transmit broadband signals in the form of pulses of light that are carried through optical fibers. The light is a form of carrier wave that is modulated to carry the broadband signals, which may contain voice, video, telemetry, and other data. In an optical fiber, the light is typically confined to a small transverse region, so that even moderate optical powers result in high optical intensities. Additionally, the light often propagates over a long distance in the optical fiber. For these reasons, nonlinear effects due to fiber nonlinearities may have significant, and often unintended, consequences. This may be true even when the pulses of light are of relatively short duration.

For instance, one of the most common nonlinear effects in optical fibers is the Kerr effect. Put simply, the Kerr effect is a change in the refractive index of a material (in this case, an optical fiber) in response to an applied electric field. Specifically, the Kerr-induced change in refractive index is directly proportional to the square of the optical intensity of the light propagating through the optical fiber (as opposed to varying linearly with the optical intensity). Additionally, phase delays in the optical fiber may increase in magnitude with increases in the optical intensity of the light. Because the optical core of the optical fiber is so small, the optical intensity per unit volume of the optical fiber can thus become very high, which prevents high bandwidth signals (which exhibit quicker phase changes) from being carried longer distances.

The Kerr effect may in turn affect various phenomena associated with fiber optic communications, including self-phase modulation, cross-phase modulation, four-wave mixing, and nonlinear self-focusing. When data rates (and, hence, laser power) are relatively low, these phenomena do not play a significant role in the communications. However, for data rates of 100 Gbps and above, higher powered lasers are needed to generate the light pulses, which results in Kerr-induced refractive index changes, and, consequently, self-phase modulation, cross-phase modulation, four-wave mixing, and/or nonlinear self-focusing.

Examples of the present disclosure provide a way to detect a phase change in a signal traversing an optical fiber that is induced by the Kerr effect. Further examples of the present disclosure provide a policy-based approach to applying one or more solutions for correcting the phase change. The solutions may include one or more of: a phase rotator, controlling the launch power of the signal using an electronic dispersion compensation (EDC) chip for dispersion management, a Raman amplifier to create solitonic pulses, or using a flexible-grid reconfigurable optical add/drop multiplexer (ROADM) to minimize four-wave mixing. By applying a combination of these solutions, the overall reach of an optical channel in a DWDM network may be increased, thereby allowing high-bandwidth optical signals to travel longer distances.

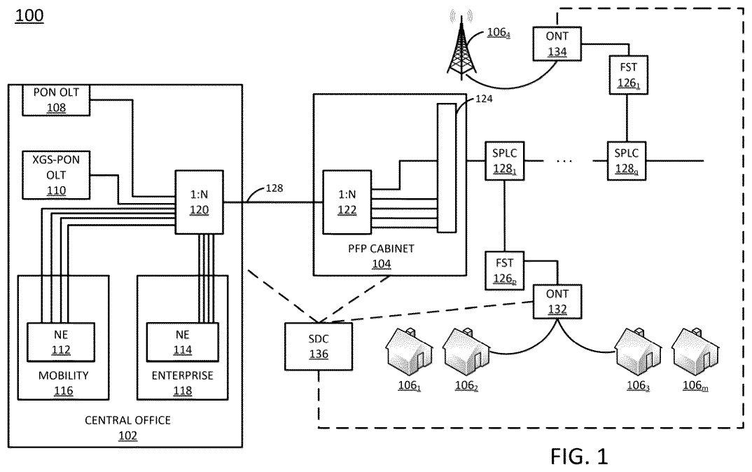

Examples of the present disclosure may be used to estimate and compensate for nonlinear effects in both existing optical fiber channels, and in new optical fiber channels that are to be launched. In further examples, machine learning techniques could be used to learn the topology of the fiber broadband network and to learn how to determine when a phase change in a light pulse propagating through the fiber broadband network is caused by nonlinear effects. The machine learning technique may further learn the optimal actions to initiate to mitigate the nonlinear effects and reduce or reverse the phase change. These and other aspects of the present disclosure are discussed in further detail with reference to FIGS. 1-3, below.

To understand the approaches disclosed herein, it is helpful to understand the physics behind the Kerr effect. A wave propagating in a dielectric material, such as silicon dioxide (SiO₂), can be represented by a nonlinear Schrodinger wave equation. If A(z,t) represents the light pulse enveloped in time t at the spatial position z, propagating from the transmitting end to the receiving end of an optical fiber communication system, then pulse propagation can be described by the nonlinear Schrodinger equation as:

$$\frac{d A}{d z} + \frac{{β}_{1} d A}{d T} - \frac{j {β}_{2} {d}^{2} A}{2 d {T}^{2}} + \frac{a}{2} A = - j {α}_{0} \vert A {\vert}^{2} A \qquad ( EQN . 1 )$$

where β₁ is the first order dispersion parameter which causes a pulse delay due to polarization mode dispersion, β₂ is the second order dispersion parameter which causes a pulse broadening due to chromatic dispersion, α is the attenuation coefficient of the optical fiber, and α₀ is the nonlinearity coefficient of the optical fiber (which is a function of the intensity of the light propagating through the optical fiber). Moreover,

$$\frac{{β}_{1} dA}{dT}$$

is the polarization mode dispersion,

$$- \frac{j {β}_{2} {d}^{2} A}{2 d {T}^{2}}$$

is the chromatic dispersion, a/2A is the attenuation loss, and −jα₀|A|²A is the nonlinearity due to the intensity of the light.

The solution to EQN. 1 may be obtained by a split step Fourier transform. When only dispersion and attenuation are considered, and the spatial position Z of the light pulse is assumed to be at zero center frequency, then the solution to EQN. 1 may be given as:

$$A ( L , ω ) = exp [ ( \frac{i {β}_{2} {ω}^{2}}{2} - \frac{α}{2} ) L ] A ( 0 , ω ) \qquad ( EQN . 2 )$$

where L is the length of the optical fiber. EQN. 2 thus measures the power of the signal (light pulse) as the signal amplitude decreases with propagation along the length of the optical fiber. As the signal loses power, chromatic dispersion will affect the phase of the signal spectrum without changing the spectral power distribution, thereby causing the light pulse to be broadened (which leads to a fading signal).

It is clear from EQN. 2 that the signal amplitude decreases as the light pulse propagates along the length of the optical fiber. This decrease in signal amplitude causes power loss and chromatic dispersion, which in turn affects the phase of the signal spectrum without changing the spectral power distribution. This causes the propagating light pulse to be broadened.

Signal attenuation as a unit of length may be expressed as:

$${α}_{d B} = - 10 L {log}_{10} ( \frac{{P}_{o u t}}{{P}_{i n}} ) \qquad ( EQN . 3 )$$

where L is measured in kilometers so that the attenuation constant, α_{dB}, is expressed in dB/km for 1550 nm.

The second order dispersion parameter, β₂, may also be referred to as group velocity dispersion. The time delay between two different spectral components separated by a certain frequency interval may be determined using the dispersion coefficient, D, according to:

$${β}_{2} = ( λ2 / 2 πC ) D \qquad ( EQN . 4 )$$

$$where$$

$$D = ( 2 πC / λ2 ) {β}_{2} \qquad ( EQN . 5 )$$

and where C represents the speed of light, A is the carrier wavelength (equal to 2πCLω), and the time delay between two different spectral components separated by a certain wavelength interval is determined by the dispersion coefficient D in ps/nm-km.

The propagation distance after which a Gaussian pulse is broadened by forty percent is referred to as the “dispersion length,” L_{D}, and may be expressed as:

$${L}_{D} = \frac{{t}_{0}^{2}}{\vert {β}_{Z} \vert} \qquad ( EQN . 6 )$$

where t₀ represents the pulse full-width at half-maximum (FWHM). The input may be represented by a Gaussian pulse and may be defined as:

$$A ( t ) = exp ( - \frac{1}{2} {( \frac{t}{{t}_{0}} )}^{2} ) \qquad ( EQN . 7 )$$

If the nonlinear length, L_{NL}, of the optical fiber (i.e., the propagation distance over which nonlinear effects become substantial) is defined as 1/αP, then the dispersion length L_{D} and the nonlinear length L_{NL} of the optical fiber can be calculated. It follows, then, that the presence of dispersion and nonlinearity in the optical fiber can be estimated. Specifically, if the length, L, of the optical fiber is at least a first threshold less than the dispersion length, L_{D}, and also a second threshold less than the nonlinear length, L_{NL}, (i.e., L<<L_{D} and L<<L_{NL}) then it can be assumed that the optical fiber does not exhibit dispersion or nonlinearity. If the length of the optical fiber is at least the first threshold less than the dispersion length, but at least a third threshold greater than the nonlinear length (i.e., L_{NL}<<L<<L_{D}), then it may be assumed that there is self-phase modulation but no dispersion. If the length of the optical fiber is at least the second threshold less than the nonlinear length, but at least a fourth threshold greater than the dispersion length (i.e., L_{D}<<L<<L_{NL}), then it may be assumed that there is dispersion but no nonlinearity. If the length of the optical fiber is at least the fourth threshold greater than the dispersion length, and at least the third threshold greater than the nonlinear length (i.e., L_{D}<<L and L_{NL}<<L), then it may be assumed that there is self-phase modulation and dispersion, which creates a soliton (i.e., a nonlinear, self-reinforcing, localized wave packet that is strongly stable, in that it preserves its shape while propagating freely, at constant velocity, and recovers it even after collisions with other such localized wave packets).

To further aid in understanding the present disclosure, FIG. 1 illustrates an example system 100 in which examples of the present disclosure for minimizing phase-delay-induced signal loss in an optical fiber of a fiber broadband communications network may operate. The system 100 may comprise at least a portion of an optical distribution network (ODN). In one example, the system 100 generally comprises a send side comprising a central office (or head end) 102 and a receive side comprising a primary flexibility point (PFP) cabinet 104 and a plurality of customer sites 106₁-106ₘ (hereinafter individually referred to as a “customer site 106” or collectively referred to as “customer sites 106”).

The central office 102 comprises a hub or centrally located point in the system 100 at which a conglomerate signal is distributed to optical nodes (e.g., in neighborhoods or premises locations). The conglomerate signal may carry voice, data, and/or video services to the customer sites 106. In one example, the central office 102 may include one or more optical line terminals (OLTs) 108 and 110. The OLTs 108 and 110 comprise the starting points of fiber optic access networks, such as a 25G or 50G PON or a higher speed XGS-PON. The central office 102 may further include one or more network elements (NEs) 112 and 114 supporting one or more service networks, such as a mobility network 116, an enterprise network 118, or another type of service network.

The OLTs 108 and 110, as well as the NEs 112 and 114, may all be connected (e.g., via Ethernet cables) to a first optical splitter 120. The first optical splitter 120 may be a 1:N optical splitter that is capable of receiving up to N transmission signals (e.g., from the OLTs 108 and 110 and the NEs 112 and 114) and converging the N transmission signals onto a single backbone feeder fiber 128.

The NEs 112 and 114 may output their transmission signals directly to the first optical splitter 120, i.e., without those transmission signals having to be combined into a single combined signal by a filter/multiplexer combination. The first optical splitter 120 can therefore output the conglomerate signal (comprising the transmission signals from the OLTs 108 and 110 and the NEs 112 and 114, which may be of multiple different wavelengths) via the backbone feeder fiber 128.

On the receive side, the cabinet 104 comprises an enclosure which houses a second optical splitter 122 and a distribution fiber cable termination panel 124. In one example, the second optical splitter 122 is a 1:N optical splitter that receives (via the backbone feeder fiber 128) the conglomerate signal that is output by the first optical splitter 120 in the central office 102. The second optical splitter 122 separates the single conglomerate signal into up to N individual signals of different wavelengths (e.g., one wavelength or range of wavelengths per individual signal) and delivers the up to N individual signals to the distribution fiber cable termination panel 124 for distribution to the customer sites 106.

From the distribution fiber cable termination panel 124, the up to N individual signals may be delivered to a plurality of flexible service terminals (FSTs) 126₁-126ₚ (hereinafter individually referred to as an “FST 126” or collectively referred to as “FSTs 126”) via a plurality of respective factory splices (SPLCs) 128₁-128_{q} (hereinafter individually referred to as a “splice 128” or collectively referred to as “splices 128”), also sometimes referred to as “tethers”).

In one example, each FST 126 is associated with one or more customer sites 106, such as homes, offices, cellular base stations (e.g., eNodeBs in long term evolution networks or gNodeBs in fifth generation networks) and other network termination equipment (NTE), radio nodes and sensors (e.g., picoradio nodes), and other customer sites. Thus, each signal of the up to N individual signals may be routed via the distribution fiber cable termination panel 124 to the FST 126 associated with the customer site 106 that is the destination for the signal. Each of the up to N individual signals may be presented via one or more native service interfaces to users at the customer sites 106. These services may include voice (e.g., plain old telephone service, voice over Internet Protocol, etc.), data (e.g., Ethernet, V.35, etc.), video, and/or telemetry services.

In fiber-to-the-premises (FTTP) connections, the fiber optic cable runs all the way into the customer sites 106 and is connected (e.g., via fiber drops) directly to an optical network terminal (ONT) 132 or 134 (also sometimes referred to as an optical network unit or ONU) which converts fiber signals (i.e., pulses of light) into data that can be rendered by the systems or user endpoint devices at the customer site 106, such as personal computers, set top boxes, smart televisions, and the like. FIG. 1 illustrates one ONT 132 serving the customer sites 106₁-106₃ and 106₅-106ₘ and one ONT 134 serving the customer site 106₄.

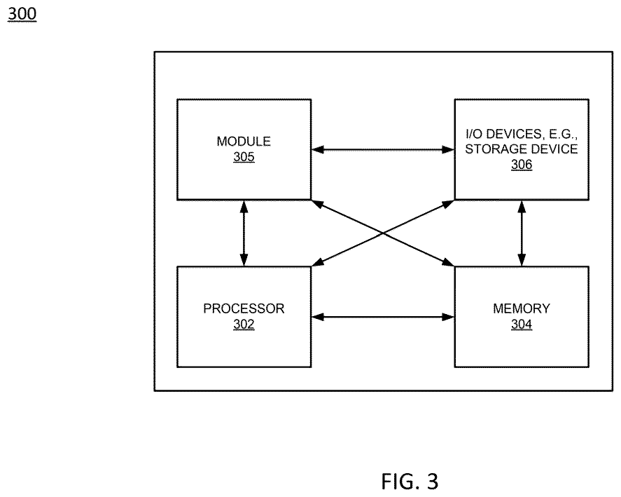

According to examples of the present disclosure, the system 100 may further include a software defined controller (SDC) 136 that is connected to the central office 102, the PFP cabinet 104, the ONT 132, and the ONT 134 and configured to perform operations for minimizing phase-delay-induced signal loss in an optical fiber of a fiber broadband communications network. In one example, the SDC 136 may be configured in a manner similar to the computing device 300 illustrated in FIG. 3. Thus, the SDC 136 may include one or more components such as memory, non-transitory computer-readable media, and the like.

In practice, the SDC 136 may collect data from the central office 102, the PFP cabinet 104, the ONT 132, and/or the ONT 134 related to the topology and optical characteristics of the system 100. The collected data may be used to estimate when a phase change in a signal propagating through an optical fiber has occurred as a result of nonlinear effects that are present in an optical fiber of the system 100 and to apply one or more solutions to mitigate the nonlinear effects, thereby allowing high-bandwidth signals to travel longer distances over the optical fiber.

In one example, the nonlinear effects may be effects that are attributable to the Kerr effect, and may include one or more of: self-phase modulation, cross-phase modulation, four-wave mixing, or nonlinear self-focusing. The nature of any solutions for mitigating these effects may depend on which effects are determined to be present. For instance, the solutions may include one or more of electronic dispersion compensation, creation of a solitonic pulse, adjustment of spacing between channels of the optical fiber, or application of a phase rotator to correct the phase change. Any combination of these solutions may be initiated depending upon the extent to which any of the above-described non-linear effects contribute to the detected phase change.

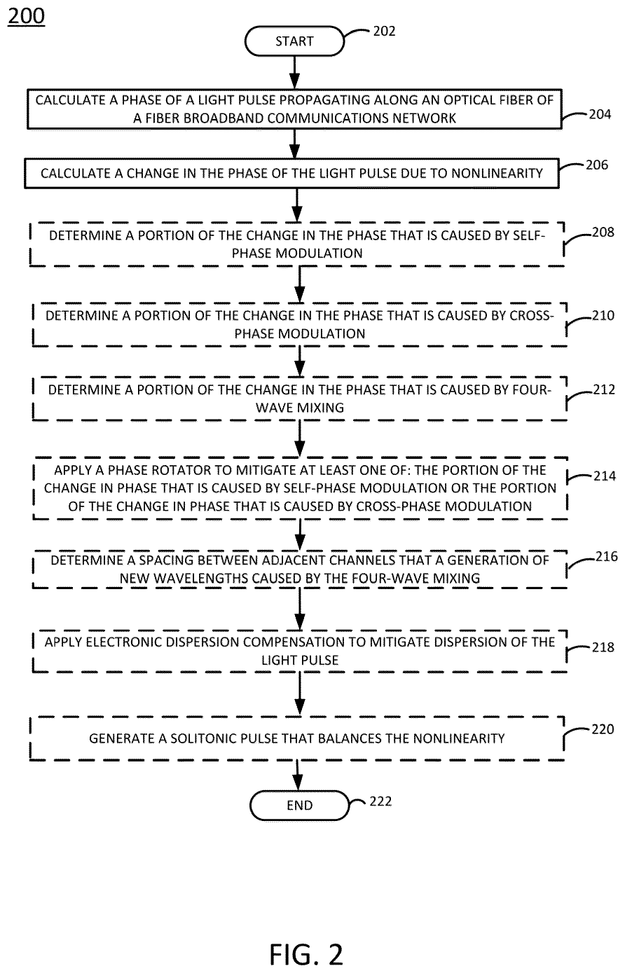

One example of a method for minimizing phase-delay-induced signal loss in an optical fiber of a fiber broadband communications network is discussed in further detail with respect to FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

To further aid in understanding the present disclosure, FIG. 2 illustrates a flowchart of an example method 200 for minimizing phase-delay-induced signal loss in an optical fiber of a fiber broadband communications network, according to the present disclosure. In one example, the method 200 may be performed by the SDC 136 of FIG. 1. However, in other examples, the method 200 may be performed by another device, such as the computing system 300 of FIG. 3, discussed in further detail below. For the sake of discussion, the method 200 is described below as being performed by a processing system (where the processing system may comprise a component of a software defined controller, the computing system 300, or another device).

The method 200 begins in step 202. In step 204, the processing system may calculate a phase of a light pulse that is propagating along an optical fiber of a fiber broadband communications network.

In one example, the phase of the light pulse may be calculated using a transponder pulse. In this case, the refractive index of the optical fiber depends upon the optical intensity of the light pulse. The effective refractive index, n, of the optical fiber may be expressed as:

$$n ( λ , \vert E {\vert}^{2} ) = {η}_{0} ( λ ) + n 2 \vert E {\vert}^{2} \qquad ( EQN . 8 )$$

whereas in fused silica, the effective refractive index, n₂, may be calculated as

$${n}_{2} = ( 2.2 - 3.4 ) ⨯ {10}^{- 29} {m}^{2} / w \qquad ( EQN . 9 )$$

where E represents the amplitude of the optical signal, m represents a modulation factor, and w represents an angular frequency.

In step 206, the processing system may calculate a change in the phase of the light pulse due to nonlinearity.

In one example, the phase change due to nonlinearity, N(I), may be calculated as:

$$N ( I ) = {η}_{0} + {η}_{2} ( I ) \qquad ( EQN . 10 )$$

where η₀ is the refractive index that does not change, and η₂ is the refractive index that changes with the intensity of the light pulse. In one example, η₂=ax3, where X represents a susceptibility of the optical fiber medium (X=X⁽¹⁾+X⁽²⁾+X⁽³⁾+ . . . , and X⁽³⁾ is the third order susceptibility of the optical fiber medium which is responsible for four-wave mixing).

Polarization in terms of susceptibility may be expressed as:

$${P}^{2} = {X}^{2} {E}^{2} \qquad ( EQN . 11 )$$

Since the optical intensity, I, of the light pulse is equal to power/area, if the area is small, then the optical intensity will be large. In a fiber core, the area will be very small, which will lead to high-intensity light pulses.

The electric field vector in the optical fiber will have both a vertical component and a horizontal component. When a probe pulse is passed through the optical fiber at an angle, the probe pulse can be detected at the end of the optical fiber according to:

$$Change in phase = angle of incident probe pulse - Φ \qquad ( EQN . 12 )$$

where φ depends on the optical intensity of the probe pulse and how closely the channels supported by the optical fiber are spaced.

In optional step 208 (illustrated in phantom), the processing system may determine a portion of the change in the phase that is caused by self-phase modulation. As discussed above, one consequence of the Kerr effect may be self-phase modulation. If the light pulse experiences self-phase modulation, this means that the light pulse experiences a nonlinear phase delay which results from the light pulse's own optical intensity.

For an optical fiber, the phase change per unit optical power and unit length is described by the proportionality constant. Effective refractive index of a dielectric material within which an electrical field is propagating may be calculated according to EQN. 8, above, whereas in fused silica, the effective refractive index may be calculated according to EQN. 9. If I represents the optical intensity of the light pulse, and the effective area is A_{eff}, then:

$$I = P / {A}_{eff} \qquad ( EQN . 13 )$$

Thus, if the power and the effective area are both known, then the change in the refractive index of the optical fiber, and, thus, the portion of the change in the phase of the light pulse due to self-phase modulation, can be calculated according to EQN. 1, above.

In optional step 210 (illustrated in phantom), the processing system may determine a portion of the change in the phase that is caused by cross-phase modulation. As discussed above, another consequence of the Kerr effect may be cross-phase modulation. Cross-phase modulation may occur when two different light pulses (e.g., at two different wavelengths) propagate simultaneously in an optical fiber, and a nonlinear phase change of each light pulse occurs as a result of the other light pulse's optical intensity. If both light pulses have the same linear polarization, then the resulting phase changes may be as much as two times larger than expected based on the equation for determining self-phase modulation (e.g., EQN. 8). The total phase change depends on the optical powers in all channels supported by the optical fiber and may vary from bit-to-bit depending upon the bit patterns of the neighboring channels. If equal optical powers are assumed in all channels, then the worst-case phase shift (i.e., in which all channels simultaneously carry one bit and all light pulses overlap) may be expressed as:

$${φ}_{i}^{N L} = ( y \vert α ) ( 2 η - 1 ) {P}_{i} \qquad ( EQN . 14 )$$

In optional step 212 (illustrated in phantom), the processing system may determine a portion of the change in the phase that is caused by four-wave mixing. Wave mixing occurs when channels supported by the same optical fiber collide with each other to form intermodulation products. This produces in-band crosstalk that cannot be filtered out. If dispersion is present, then the collision signal will co-occur with the signal embodied in the light pulse.

In optional step 214 (illustrated in phantom), the processing system may apply a phase rotator to mitigate at least one of: the portion of the change in phase that is caused by the self-phase modulation or the portion of the change in phase that is caused by the cross-phase modulation.

In one example, the launch power of the light pulse may be reduced simultaneously with the application of the phase rotator. The combination of the phase rotator and the reduced launch power may be sufficient to bring both the self-phase modulation and the cross-phase modulation to within bounds that minimize the total phase change of the light pulse due to nonlinearity.

In one example, the launch power may be reduced to a power that is determined to be optimal to minimize amplified spontaneous emission (i.e., light, produced by spontaneous emission, that has been optically amplified by the process of stimulated emission in a gain medium) and nonlinearity. In general, lower launch power may lead to higher amplified spontaneous emissions, while higher launch powers will be limited by distortions due to nonlinearity. Thus, examples of the present disclosure may extrapolate between relatively lower and relatively higher launch powers to identify a launch power for which both amplified spontaneous emissions and distortions due to nonlinearity are minimized or at least brought within acceptable ranges.

In optional step 216 (illustrated in phantom), the processing system may determine a spacing between adjacent channels that will lower a generation of new wavelengths caused by four-wave mixing. In one example, the processing system may adjust the spacing between the adjacent channels according to the spacing that is determined. The adjacent channels are both channels supported by the optical fiber. In one example, the spacing between the adjacent channels may be further optimized to reduce cross-phase modulation as well.

In optional step 218 (illustrated in phantom), the processing system may apply electronic dispersion compensation to mitigate dispersion of the light pulse. In one example, electronic dispersion compensation levels may be managed via a mechanism that is built in as part of the transponder frames. The transponder frames in this case provide counts for corrected zeros and corrected ones as part of forward error correction computations. In one example, the processing system may use these counts to adjust the decision threshold used to detect appropriate levels of zeros and ones in the frames. Dispersion management may reduce the four-wave mixing.

In optional step 220 (illustrated in phantom), the processing system may generate a solitonic pulse that balances the nonlinearity. As discussed above, in some cases both dispersion and self-phase modulation may be present, which creates a soliton. In one example, a Raman amplifier may be used to generate a solitonic pulse that balances this nonlinearity (i.e., balances the soliton).

The method 200 may end in step 222.

It should be noted that various steps of the method 200 are described as optional, because a phase change of a light pulse in an optical fiber could be attributable to any one or more causes that are triggered by the Kerr effect (or other nonlinear effects), such as self-phase modulation, cross-phase modulation, four-wave mixing, nonlinear self-focusing, or others. Some of these causes may contribute more than others (or not at all) to the phase change. Moreover, any action or actions that are initiated to mitigate the phase change may depend on the determined causes of the phase change.

Although not expressly specified above, one or more steps of the method 200 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, the SDC 136 of FIG. 1 could be implemented as illustrated in FIG. 3.

As depicted in FIG. 3, the system 300 comprises a hardware processor element 302, a memory 304, a module 305 for minimizing phase-delay-induced signal loss in an optical fiber of a fiber broadband communications network, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for minimizing phase-delay-induced signal loss in an optical fiber of a fiber broadband communications network may include circuitry and/or logic for performing special purpose functions relating to learning the topology and optical characteristics of a fiber broadband network and for minimizing nonlinearities that may lead to phase changes in the signals traversing the fiber broadband network. The input/output devices 306 may include, for example, storage devices (including but not limited to, a tape drive, a floppy drive, a hard disk drive or a compact disk drive), a receiver, a transmitter, a transceiver, an electrical interface, an optical interface, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for minimizing phase-delay-induced signal loss in an optical fiber of a fiber broadband communications network (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for minimizing phase-delay-induced signal loss in an optical fiber of a fiber broadband communications network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
calculating, by a processing system including at least one processor, a phase of a light pulse that is propagating along an optical fiber of a fiber broadband communications network;
calculating, by the processing system, a change in the phase of the light pulse due to a nonlinearity;
determining, by the processing system, a cause of a portion of the change in the phase, wherein the cause is at least one of: a self-phase modulation, a cross-phase modulation, or a four-wave mixing; and
initiating, by the processing system, at least one action to mitigate the nonlinearity, wherein the at least one action is selected based on the cause that is determined.

2. The method of claim 1, wherein the calculating the phase of the light pulse is performed using a transponder pulse.

3. The method of claim 1, wherein the cause is the self-phase modulation, and the at least one action comprises:
applying, by the processing system, a phase rotator to mitigate the self-phase modulation.

4. The method of claim 3, wherein the at least one action further comprises reducing a launch power of the light pulse simultaneously with the applying the phase rotator.

5. The method of claim 4, wherein the launch power is reduced to a power that balances a mitigation of the self-phase modulation with a minimization of amplified spontaneous emissions.

6. The method of claim 1, wherein the cause is the cross-phase modulation, and the at least one action comprises:
applying, by the processing system, a phase rotator to mitigate the cross-phase modulation.

7. The method of claim 6, wherein the at least one action further comprises reducing a launch power of the light pulse simultaneously with the applying the phase rotator.

8. The method of claim 7, wherein the launch power is reduced to a power that balances a mitigation of the cross-phase modulation with a minimization of amplified spontaneous emissions.

9. The method of claim 1, wherein the cause is the four-wave mixing, and the at least one action comprises adjusting a spacing between adjacent channels of the optical fiber.

10. The method of claim 1, wherein the cause is the cross-phase modulation, and the at least one action comprises adjusting a spacing between adjacent channels of the optical fiber.

11. The method of claim 1, further comprising:
applying, by the processing system, an electronic dispersion compensation to mitigate a dispersion of the light pulse.

12. The method of claim 1, wherein the cause is the self-phase modulation and a dispersion that cooperate to form a soliton, and the at least one action comprises generating a solitonic pulse that balances the soliton.

13. The method of claim 12, wherein the solitonic pulse is generated using a Raman amplifier.

14. A non-transitory computer-readable medium storing instructions which, when executed by a processing system including at least one processor, cause the processing system to perform operations, the operations comprising:
calculating a phase of a light pulse that is propagating along an optical fiber of a fiber broadband communications network;
calculating a change in the phase of the light pulse due to a nonlinearity;
determining a cause of a portion of the change in the phase, wherein the cause is at least one of: a self-phase modulation, a cross-phase modulation, or a four-wave mixing; and
initiating at least one action to mitigate the nonlinearity, wherein the at least one action is selected based on the cause that is determined.

15. The non-transitory computer-readable medium of claim 14, wherein the cause is at least one of: the self-phase modulation or the cross-phase modulation, and the at least one action comprises:
applying a phase rotator to mitigate the self-phase modulation or the cross-phase modulation.

16. The non-transitory computer-readable medium of claim 15, wherein the at least one action further comprises reducing a launch power of the light pulse simultaneously with the applying the phase rotator.

17. The non-transitory computer-readable medium of claim 16, wherein the launch power is reduced to a power that balances a mitigation of the self-phase modulation with a minimization of amplified spontaneous emissions.

18. The non-transitory computer-readable medium of claim 14, wherein the cause is at least one of: the cross-phase modulation or the four-wave mixing, and the at least one action comprises adjusting a spacing between adjacent channels of the optical fiber.

19. The non-transitory computer-readable medium of claim 14, wherein the cause is the self-phase modulation and a dispersion that cooperate to form a soliton, and the at least one action comprises using a Raman amplifier to generate a solitonic pulse that balances the soliton.

20. An apparatus comprising:
a processor; and
a non-transitory computer-readable medium storing instructions which, when executed by the processor, cause the processor to perform operations, the operations comprising:
calculating a phase of a light pulse that is propagating along an optical fiber of a fiber broadband communications network;
calculating a change in the phase of the light pulse due to a nonlinearity;
determining a cause of a portion of the change in the phase, wherein the cause is at least one of: a self-phase modulation, a cross-phase modulation, or a four-wave mixing; and
initiating at least one action to mitigate the nonlinearity, wherein the at least one action is selected based on the cause that is determined.
